(19) United States
(12) Patent Application Publication
(10) Pub. No.: US 2015/0150079 A1
(43) Pub. Date: May 28, 2015

(54) METHODS, SYSTEMS AND DEVICES FOR NETWORK SECURITY

(71) Applicant: BLUECAT NETWORKS INC., TORONTO (CA)

(72) Inventors: RICHARD HYATT, MARKHAM (CA); STEVEN MEYER, RICHMOND HILL (CA); BRANKO MISKOV, TORONTO (CA); THOMAS BORREL, TORONTO (CA)

(21) Appl. No.: 14/554,835

(22) Filed: Nov. 26, 2014

Related U.S. Application Data
(60) Provisional application No. 61/908,908, filed on Nov. 26, 2013.

(51) Int. Cl. H04L 29/06; H04L 29/08; H04L 12/26

(52) U.S. Cl. CPC H04L 63/20; H04L 43/045; H04L 67/1097; H04L 63/10
USPC 726/1

(57) ABSTRACT

Devices, systems, and methods for observing and intercepting network activity for network data resources passing through one or more network security apparatuses and updating configuration of said apparatuses to control the network activity from one or more network computing devices. A spectrum of admissibility of network access may be used to configure network security apparatuses to allow or deny access to network data resources according to their position in the spectrum of admissibility and to display network characteristics in a graphical form

### FIELD

Embodiments described herein relate to the field of network communication, and in particular, embodiments described herein relate to configuration of network security devices.

### BACKGROUND

The Internet is constantly expanding in terms of number of network devices (e.g. desktop computers, laptop computers, tablets, mobile devices). The volume of traffic and types of data carried on networks continue to grow.

Malicious, hostile or intrusive software or hardware is used to disrupt computer operation, gather sensitive information, gain unauthorized access to computer systems, and so on. The associated risks of encountering malicious software, infected content, hacking and other undesirable activities also continue to grow.

Network security apparatuses, such as network firewalls, gateways, routers, Software Defined Networking (SDN) switches and so on, hereafter referred to as ‘firewalls’, have been used to shield local networks and computer systems from incoming network attacks and to prevent unauthorized network activity. A firewall may be a software-based or hardware-based network security apparatus that is operable to control incoming and outgoing network traffic. A firewall may establish a barrier between a trusted, secure internal network and another network (e.g., the Internet or another internal network) that is not assumed to be secure and trusted. A firewall may redirect and even modify network traffic flow and content in accordance with software instructions.

Sophistication of network attacks is a difficult and expensive challenge for maintenance of firewalls and network security systems. For example, maintenance may require constant upgrades to firewall configurations.

Attacks may exploit the fact that once a network security perimeter has been successfully breached, the attacker acquires full and democratic access to the secure area. Firewalls may need to work in conjunction with other layers of security controls. A feature of firewalls is the ability for deep packet inspection, which may allow for detailed protocol detection and consequently protocol-related controls. However, the use of tunneling and encryption by network client devices may limit this capability. Firewalls may be limited in the amount of information they can keep for future reference and may not maintain extensive history data about previous connections. Generally, techniques that use historical analysis may not be implemented solely within a firewall.

Firewalls may include Quality-of-Service (QoS) support that may separate network traffic into classes and give preference to more time-sensitive and important traffic. However, configuration of this support may be difficult.

Detection of worm propagation from an enterprise network may rely on the correlation of Domain Name System (DNS) queries with outgoing connections from an enterprise network.

Security issues may result from known approaches because both legitimate and malware clients may or may not perform DNS queries.

Some methods may not accommodate more subtle relationships between domain requests and firewall accesses, such as the behaviour of one client affecting the rule for another client. Some methods may not take into account the history of requests and may not work well with cached DNS responses.

There exists a need for methods, devices, and systems of automating firewall configuration are therefore needed, or at least alternatives. There exists a need for improved network security systems, or at least alternatives.

### SUMMARY

In accordance with one aspect, there is provided a device, system and method for observing and intercepting network activity passing through one or more network security apparatuses and updating configuration of said apparatuses to control the network messages from one or more network computing devices.

In accordance with another aspect, there is provided a method for updating configuration of one or more network security apparatuses. The method may involve capturing, at a processor, network activity events by a plurality of computing network devices. Each network activity event references a network data resource. The method may involve providing, in a persistent data store, a spectrum of admissibility of network access. The spectrum of admissibility may link to domain queries, client devices making domain queries, software applications making domain queries, and so on.

A method may involve for each network data resource referenced by a network activity event: determining, using the processor, a position in the spectrum of admissibility of the respective network data resource. The spectrum of admissibility may link a position to domain queries, client devices making domain queries, software applications making domain queries, and so on. A method may involve storing, in the persistent data store, a network data resource record. The network data resource record may comprise a network data resource identifier identifying the respective network data resource and the position in the spectrum of admissibility of the respective network data resource.

A method may involve configuring, using the processor and the network data resource record, one or more network security apparatuses to allow or deny access to the respective network data resource according to the position in the spectrum of admissibility of the respective network data resource.

The method may involve a network data resource that may be an IP address associated with a DNS domain name.

The method may involve intercepting and delaying DNS response network activity until after configuring of the network security apparatus.

The method may involve network activity events with one or more domain queries by one or more client devices. The one or more client devices may be at positions in the spectrum of admissibility within a user-specific safe range of the spectrum. The method may involve improving positions of the one or more domain queries in the spectrum of admissibility based on the one or more client devices.

The method may involve network activity events with one or more domain queries by one or more client device. The one or more client devices may be at positions in the spectrum of admissibility within a user-specific unsafe range of the spectrum. The method may involve reducing positions of the one or more domain queries in the spectrum of admissibility based on the one or more client devices.

The method may involve network activity events with a pattern of domain queries. The method may involve mapping a pattern of domain queries to a software application on a spectrum of admissibility of applications where the appearance of the pattern of captured domain queries within a small timeframe may correlate closely or exactly with a similar pattern identified with the software application. One or more of the domain queries may be allowed or denied according to the position on the spectrum of admissibility of the software application. Accordingly domains that are captured individually may be treated differently from domains that are captured in a pattern. That is, the same domain queries may be treated differently if they occur in isolation as opposed to being captured in a pattern of domain queries. Further, the ability of delaying the DNS responses as described herein may allow the pattern of domain queries to be examined before responding to the domain queries. This may not preclude a case where the pattern depends on a sequence that requires one or more past events to be included in the correlation. For example, if domain A is queried (and responded) and followed within a short time by domains B, C, D etc. then that may correlate with a particular software application X. In accordance with some embodiments, the software application that runs on a client may be identified by the domain requests it makes. In accordance with other embodiments, the domain requests may be identified within the software application. Embodiments described herein may provide a device configured to map the software application to a position on the spectrum of admissibility and may use the position to allow or deny the domain requests by the client associated with the software application.

The method may involve a network data resource with a device identifier and device type associated with a network IP address.

The method may involve capturing a user identifier of a user associated with a network computing device of the plurality of network computing devices, wherein the network computing device is associated with the network IP address; determining a position of the user on the spectrum of admissibility; storing, in the data store, a user record, wherein the user record comprises the user identifier of the user, the device identifier, the device type and the position of the user in the spectrum of admissibility; and configuring, using the processor, the one or more network security apparatuses to allow or deny access to a network data resource associated with the user using the user record.

The method may involve capturing a user group identifier of a user associated with a network computing device of the plurality of network computing devices, wherein the network computing device is associated with the network IP address; determining a position of the user group on the spectrum of admissibility; storing, in the data store, a user group record, wherein the user record comprises the user group identifier of the user, the device identifier, device type and the position of the user in the spectrum of admissibility; and configuring, using the processor, the one or more network security apparatuses to allow or deny access to a network data resource associated with the user using the user group record.

The method may involve sharing and coordinating the spectrum of admissibility stored in the data store with the plurality of network computing devices to capture additional network activity events; and updating network data resource records based on the additional network activity events; and updating configuration of the one or more network security apparatuses based on the updated network data resource records.

The method may involve allowing access, by the one or more network security apparatuses, to a destination network resource by setting a QoS for the destination network resource.

The method may involve updating the configuration of the one or more network security apparatuses by setting one or more rules for later execution by the one or more network security apparatuses.

The method may involve providing a user interface displaying network characteristics in a graphical form as a representation of a status and activity of the network, wherein a first axis of the graphical form comprises the spectrum of admissibility. A second axis of the graphical form may be the frequency of access requests for one or more network resources. As another example, a second axis of the graph may be the frequency of site requests from a client device.

The method may involve receiving command requests at the user interface to update the position in the spectrum of admissibility of a network resource, and re-configuring the one or more network security apparatuses in response to the command request.

In another aspect, embodiments described herein may provide a system for updating configuration of one or more network security apparatuses that may include a data store storing a spectrum of admissibility of network access and a plurality of network data resource records; a network security controller comprising a processor configured to: capture network activity events by a plurality of computing network devices, wherein each network activity event references a network data resource; for each network data resource referenced by a network activity event: determine a position in the spectrum of admissibility of the respective network data resource; updating a network data resource record of the plurality of network data resource records, wherein the network data resource record comprises a network data resource identifier identifying the respective network data resource and the position in the spectrum of admissibility of the respective network data resource; and configure, using the updated network data resource record, one or more network security apparatuses to allow or deny access to the respective network data resource according to the position in the spectrum of admissibility of the respective network data resource.

The network data resource may include an IP address associated with a DNS domain name. The network data resource may include a device identifier and device type associated with a network IP address.

The network security controller may be further configured to capture a user identifier for a user associated with the network computing device associated with the network IP address and determine a position of the user on the spectrum of admissibility.

The network security controller may be further configured to capture a user group identifier for a user associated with the network computing device associated with the network IP address and determine a position of the user group on the spectrum of admissibility.

The system may also include a display device configured with a user interface displaying network characteristics in a graphical form as a representation of a status and activity of the network, wherein a first axis of the graphical form comprises the spectrum of admissibility.

In a further aspect, embodiments described herein may provide a computing device for monitoring and controlling network activity and updating configuration of a network security apparatus. The device may include one or more components to access, in a data store, a spectrum of admissibility of network access and a plurality of network data resource records; one or more components to capture network activity events by a plurality of computing network devices, wherein each network activity event references a network data resource; for each network data resource referenced by a network activity event, one or more components to: determine a position in the spectrum of admissibility of the respective network data resource; updating a network data resource record of the plurality of network data resource records, wherein the network data resource record comprises a network data resource identifier identifying the respective network data resource and the position in the spectrum of admissibility of the respective network data resource; and configure, using the updated network data resource record, one or more network security apparatuses to allow or deny access to the respective network data resource according to the position in the spectrum of admissibility of the respective network data resource.

The network data resource may include an IP address associated with a DNS domain name. The network data resource may include a device identifier and device type associated with a network IP address.

The device may include one or more components for capturing a user identifier for a user associated with the computing device associated with the network IP address and determining a position of the user on the spectrum of admissibility.

The device may include one or more components for capturing a user group identifier for a user associated with the computing device associated with the network IP address and determining a position of the user on the spectrum of admissibility.

The device may include a display device configured with a user interface displaying network characteristics in a graphical form as a representation of a status and activity of the network, wherein a first axis of the graphical form comprises the spectrum of admissibility.

Many further features and combinations thereof concerning the present improvements will appear to those skilled in the art following a reading of the instant disclosure.

### DESCRIPTION OF THE FIGURES

Various aspects and embodiments are shown in the drawings, and described in connection therewith.

FIG. 1 is a schematic diagram of a network security system including network capturing devices, a security supervisor and a network security apparatus (for example, a firewall) according to some embodiments.

FIG. 2 is schematic diagram of an example spectrum of admissibility that ranks admissibility to network access according to some embodiments.

FIG. 3 shows an example of the flow of network security control logic according to some embodiments.

FIG. 4 shows an example of the control logic for configuring hardware to determine admissibility using the pattern data store according to some embodiments.

FIG. 5 illustrates an example schematic of a logical visualization of the network domain traffic relative to the spectrum of admissibility according to some embodiments.

FIG. 6 illustrates another example schematic of a logical visualization of the network client traffic relative to the spectrum of admissibility according to some embodiments.

Numerous specific details are set forth in order to provide a thorough understanding of the exemplary embodiments described herein. However, the embodiments described herein may be practiced without these specific details.

### DETAILED DESCRIPTION

In one aspect, embodiments described herein relate to methods, systems, and devices for network security that may apply firewall rules to outgoing communications, internal network communications, incoming communications, and so on. Embodiments described herein relate to methods, systems, and devices for network security that may apply firewall rules based on broadly observed current and historical network interactions. Embodiments described herein relate to methods, systems, and devices for network security that may automatically configure firewall rules to distinguish between legitimate user addresses (e.g. safe addresses), suspect addresses and known bad addresses (e.g. blocked addresses).

In another aspect, embodiments described herein may relate to systems, methods, and devices for observing and capturing network activity and updating configuration of a network security apparatus to control the outgoing network messages from a network computing device. The network messages may also be internal, incoming, and so on.

Embodiments described herein may use aggregated higher-level network information for security mechanisms.

The systems, methods, and devices may involve hardware components for capturing and recording network event data objects (e.g. events) referencing resources relating to network activity. A variety of network events may be observed and intercepted, such as, but not limited to, IP addresses assigned to host computer devices, host computers devices registered by users and domains and IP addresses of network destination resources queried and responded using the DNS protocol. The network events may also include obtaining a device identifier and a device type for a network computing device associated with a network IP address. The network events may also be used for capturing a user identifier of a user associated with the network computing device associated with the network IP address. Network events may also be captured from other activities, including, but not limited to, network discovery protocols, such as MDNS, UPnP, WS_DISCOVERY, network probes detected at a firewall and network traffic usage events. These are illustrative and non-limiting examples.

The systems, methods, and devices may involve hardware components configured to, for each destination resource, determine a position in a spectrum of admissibility of network access by a computing network device. Positions may fall into different ranges including, blocked, attribute-blocked, suspicious, neutral, familiar, attribute-safe and safe. A position may indicate a relative point along the spectrum. The position may dynamically update and change according to observed network activity, pre-configurations, observed patterns of network activity, trusted sources, and so on.

The systems, methods, and devices may involve a hardware data store for persistently storing the spectrum of admissibility, and updates thereto. The hardware data store may be designed for scalability to provide network services to multiple networks.

The systems, methods, and devices may involve hardware components for configuring a network security apparatus to allow or deny access to each destination resource according to the position in the spectrum of admissibility. As noted, the position for a network resource may be modified dynamically over time.

In another aspect, embodiments described herein relate to methods, systems and devices for observing and capturing the behaviour of a network (e.g. local network) and dynamically setting up, configuring, updating, verifying, and maintaining network security device rules in real time in accordance with the observed patterns of network activity, including DNS requests, device types and device user registrations. Capturing the behavior of the network may include, without limitation, recording the client addresses requesting a domain, recording the date of domain requests, recording the time of domain requests and keeping a count of the number of times a domain is requested.

In another aspect, embodiments described herein relate to memory hardware (e.g. persistent store) configured with a policy data store or database that may be maintained of sites that fall within a spectrum of admissibility. At the inadmissible end of the spectrum are externally supplied site names from a blocked list while at the admissible end of the spectrum may be site names from an externally supplied safe list. Sites that are observed on the network and which are not part of the blocked or safe lists may be dynamically placed on the spectrum according to predetermined behaviour patterns.

Embodiments described herein may also involve setting up of rules on a network security device, such as a firewall, for sites in accordance with the sites' position on the spectrum. For example, behavior patterns may include multiple DNS requests for a particular site domain from a number of different client computers at different times, or a client computer requesting a sequence of site domains in a predictable order at regular intervals. In the first example, a rule may be created to allow such a site to be accessed, as it appears to be familiar to a number of client devices. In the second example, if at least one of the domains appears on the blocked list a rule may be created to block access to all the sites in the sequence. These are illustrative examples and other examples are possible.

In another aspect, embodiments described herein may approve or deny admissibility of a site, which may depend on what type of device is making the network request. Admissibility or inadmissibility of network access may be determined by attribute-specific blocked and attribute-specific safe lists. The attribute may be a device type.

In another aspect, in accordance with some embodiments described herein, admissibility of the site may depend on the identity of the user or group associated with the user registered with the device making the network request. Admissibility or inadmissibility of network access may be determined by user-specific blocked and user-specific safe lists, where the attribute is a user or group association. These are example attributes and other attributes may be applied to rules, for example there may be client-location-specific rules and time-of-day-specific rules.

In another aspect, in accordance with some embodiments described herein, regular and frequent observation over time of specific site requests from client devices that are known and therefore trusted on the network may result in those sites being added to the safe list for the network for some other or all client devices.

In a further aspect, embodiments described herein may share or use one or more entries in the policy data store of one system with the policy data store of another system to allow network security rules to be coordinated across different networks. For example, if a client in one network makes regular and frequent access over time to a particular site in one network security system, then that site may be considered safe for use by other systems.

In yet another aspect, in accordance with some embodiments described herein, DNS responses may be delayed in order to allow the network security devices to be correctly and dynamically configured.

In a further aspect, in accordance with some embodiments described herein, the pattern of site requests may allow the determination of which software applications are giving rise to network activity. This in turn may provide a match in the policy data store of safe applications and blocked applications. This may also influence dynamic network security rules for admissibility and inadmissibility, respectively.

In order to maintain consistency between the network security rules and the DNS queries, the TTL (time-to-live) of the DNS responses must be less than the validity time of the policy data store entries. Embodiments described herein may provide, methods, systems and devices for modifying the TTL values to maintain valid timing.

In another aspect, the method or devices may involve network activity events defining a pattern of domain queries. A device may be configured to map a pattern of domain queries to a software application on a spectrum of admissibility of software applications. The appearance of the pattern of captured domain queries within a small timeframe may correlate closely or exactly with a similar pattern identified using the software application. The device may allow or deny one or more of the domain queries of a pattern of domain queries according to the position on the spectrum of admissibility of the software application. Accordingly domains that are captured individually may be treated differently than domains that are captured in a pattern. That is, the same domain queries may be treated differently if they occur in isolation as opposed to being captured in a pattern of domain queries. Further, the ability of delaying the DNS responses as described herein may allow the pattern of domain queries to be examined before responding to the domain queries. This may not preclude a case where the pattern depends on a sequence that requires one or more past events to be included in the correlation. For example, if domain A is queried (and responded) and followed within a short time by domains B, C, D etc. then the pattern may correlate with a particular software application X.

In accordance with some embodiments, the software application that runs on a client may be identified by the domain requests it makes. In accordance with other embodiments, the domain requests may be identified within the software application.

Embodiments described herein may provide a device configured to map the software application to a position on the spectrum of admissibility and may use the position to allow or deny domain requests by the client associated with the software application.

In a further aspect, in accordance with some embodiments, the Quality of Service (QoS) or a network security device, such as a firewall/gateway, may be set according to the position of the destination site on the admissibility spectrum.

In a further aspect, in accordance with some embodiments, a group of sites forming a domain profile may be collectively placed on the admissibility spectrum.

Firewalls may operate using real-time packet inspection, and in more advanced implementations, deep packet inspection. Embodiments described herein may make use of ‘extrafirewall intelligence’, such as domain names and aggregated historical network intelligence to inform and control the firewall rules.

Embodiments described herein may involve accumulating data from a number of network sources, particularly DNS and DHCP servers and maintaining a data store.

Embodiments described herein may maintain an evaluated list (spectrum) of addresses and sites to be trusted or blocked and uses cooperation between firewall supervisors to adjust the valuations of items in the list.

Embodiments described herein may involve a firewall that may be configured to implement Quality of Service (QoS) rules. This may be useful in conjunction with setting traffic service levels dependent on the site's position in the spectrum of admissibility.

Detecting and blocking network malicious activities may block such activities at their first attempt to leave a given network in the absence of a DNS lookup. However, not every access is preceded by a DNS request due to caching, and certain sites may be accessed by several client devices, leading to redundant requests. Therefore a more sophisticated method of controlling may be provided by the embodiments described herein.

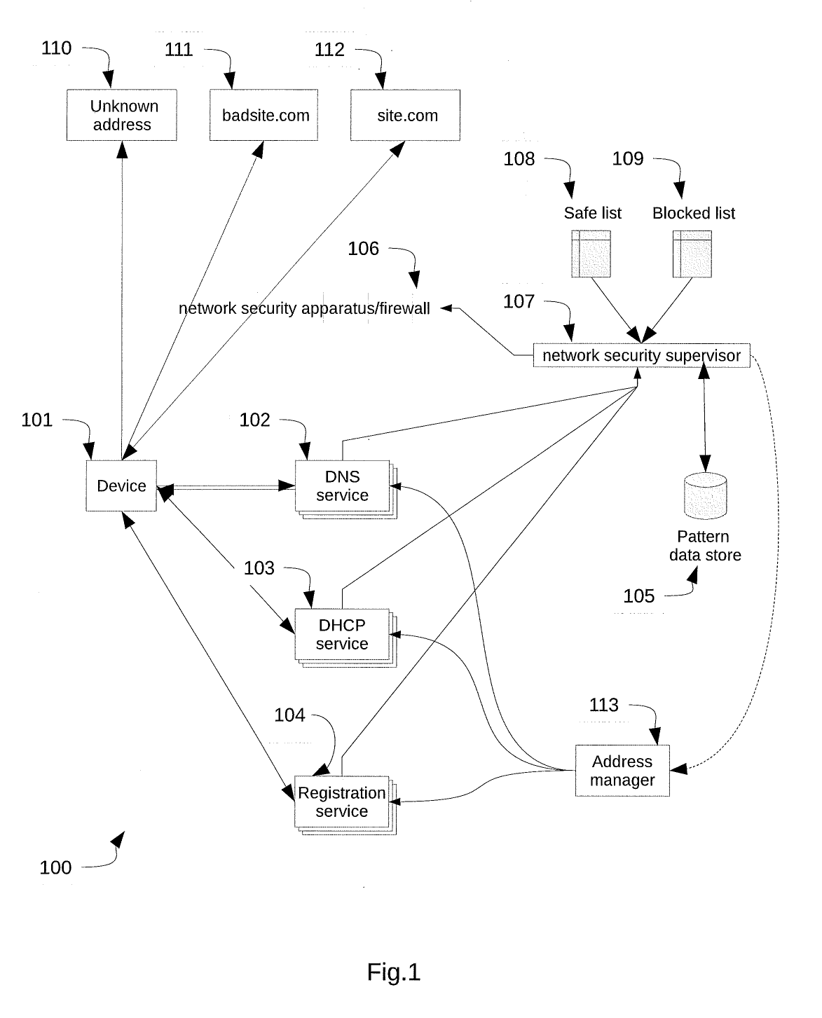

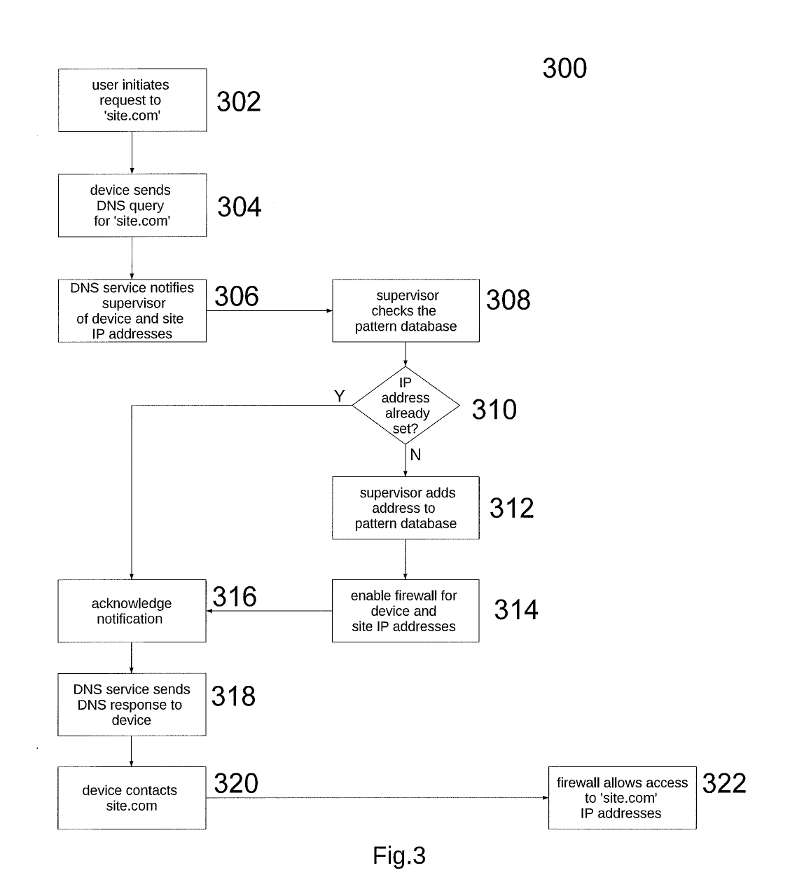

FIG. 1 shows a network security system 100 according to some embodiments. FIG. 3 shows an example of method 300 of network security control logic.

At 302, computing device 101 (e.g. a physical hardware device or a virtualized computing device running in a virtual computing environment) may initiate request to contact a network resource, such as for example, an Internet site ‘site.com’ 112.

For simplicity only one computing device 101 is shown but system may include one or more computing devices 101 operable by users to access remote network resources 110, 111, 112. The computing devices 101 may be the same or different types of devices. The computing device 101 may be implemented using one or more processors and one or more data storage devices configured with data store(s) or file system(s), or using multiple devices or groups of storage devices distributed over a wide geographic area and connected via a network (which may be referred to as “cloud computing”).

Computing device 101 may reside on any networked computing device, such as a personal computer, workstation, server, virtual machine computing device, cloud computer, portable computer, mobile device, personal digital assistant, laptop, tablet, smart phone, an interactive television, video display terminals, gaming consoles, electronic reading device, and portable electronic devices or a combination of these.

Computing device 101 may include any type of processor, such as, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Computing device 101 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Computing device 101 may include one or more input devices, such as a keyboard, mouse, camera, touch screen and a microphone, and may also include one or more output devices such as a display screen and a speaker. Computing device 101 has a network interface in order to communicate with other components, to access and connect to network resources, to serve an application and other applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. There may be more computing devices 101 distributed over a geographic area and connected via a network. Computing device 101 is operable to register and authenticate users (using a login, unique identifier, and password for example) prior to providing access to applications, a local network, network resources, other networks, and network security devices. Computing devices 101 may be different types of devices and may serve one user or multiple users.

At 304 (FIG. 3) computing device 101 may contact DNS service 102 in order to obtain the IP address of the site. DNS service 102 may implement a hierarchical distributed naming system for computers, services, or other network resources. DNS service 102 may associate various information and attributes with domain names assigned to each participating entity. DNS service 102 may translate domain names to the numerical IP addresses needed for the purpose of locating computer services, devices and other network resources.

DNS service 102 may be implemented using a server and data storage devices configured with data store(s) or file system(s), or using multiple servers or groups of servers distributed over a wide geographic area and connected via a network. DNS service 102 may be connected to a data storage device directly or via to a cloud based data storage device via network. DNS service 102 may reside on a networked computing device including a processor and memory. The data storage devices may be used to provide a persistent store for administrating and providing DNS services.

At 306 (FIG. 3), DNS service 102 may return the requested IP address for site.com 112 to device 101, and at the same time is operable to notify the network security supervisor 107 that the device 101, identified by its IP address, requests to contact site.com 112. In accordance with some embodiments, the DNS service 102 may delay the DNS response by a small amount of time in order for the notification to be acted upon before the requesting computing device 101 attempts to make use of the DNS response IP address.

Network security supervisor 107 may reside on a networked computing device. Network security supervisor 107 may be implemented using one or more processors and one or more data storage devices configured with data store(s) or file system(s), or using multiple devices or groups of storage devices distributed over a wide geographic area and connected via a network

Network security supervisor 107 may include a processor, such as, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Computing device 101 may include any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

The network security supervisor 107 includes or is connected to a memory configured with control logic to provide a pattern data storage device 105. The pattern data storage device 105 maintains a record of each domain (or more generally network resource) and a corresponding position on the accessibility spectrum 200. The record may include a network resource identifier identifying the network resource, such as a domain, along with its corresponding position on the accessibility spectrum 200. For example, the position may be a value between 0 (permanently blocked) and 100 (always safe). Other indications of position relative to the spectrum may be used. The spectrum 200 may be divided into ranges (e.g. segments, portions), such as a safe range, a neutral range, a blocked or high risk range, and so on. The record may be updated as the position changes. The pattern data storage device 105 may include additional records, such as a user record with a user identifier, its corresponding position on the accessibility spectrum 200, a device type, a device identifier identifying a device associated with the user and so on. The pattern data storage device 105 may include a user group record with a user group identifier and its corresponding position on the accessibility spectrum 200, and so on. These records may be accessed and used by the network security supervisor to configure one or more firewalls.

In accordance with some embodiments, the position spectrum may be associated with a validity time range which determines both the length of time that an address may be allowed by the firewall and the modified time-to-live (TTL) value provided by the DNS service. The TTL for a specific domain may not be longer than the validity time for the same domain, but it may be shorter if the original DNS TTL is shorter.

At 308 (FIG. 3), the network security supervisor 107 may check in its pattern data storage device 105 for data relating to site.com 112. At 310, network security supervisor 107 may determine whether the IP address for site.com is already set in the pattern data storage device 105. If it is a new site, at 312, the network security supervisor 107 adds the IP address to the pattern data storage device 105, and at 314 may configure a firewall or other security device to allow or deny access to the site by computing device 101.

At 316, network security supervisor 107 acknowledges notification of the request to access the site by the device. At 318, DNS service 102 may send a DNS response to the device if permitted by the position on the accessibility spectrum of the site, user, device or a combination thereof. If access is permitted, at 320, computing device 101 contacts site.com and at 322 the firewall allows device to access IP addresses for site.com.

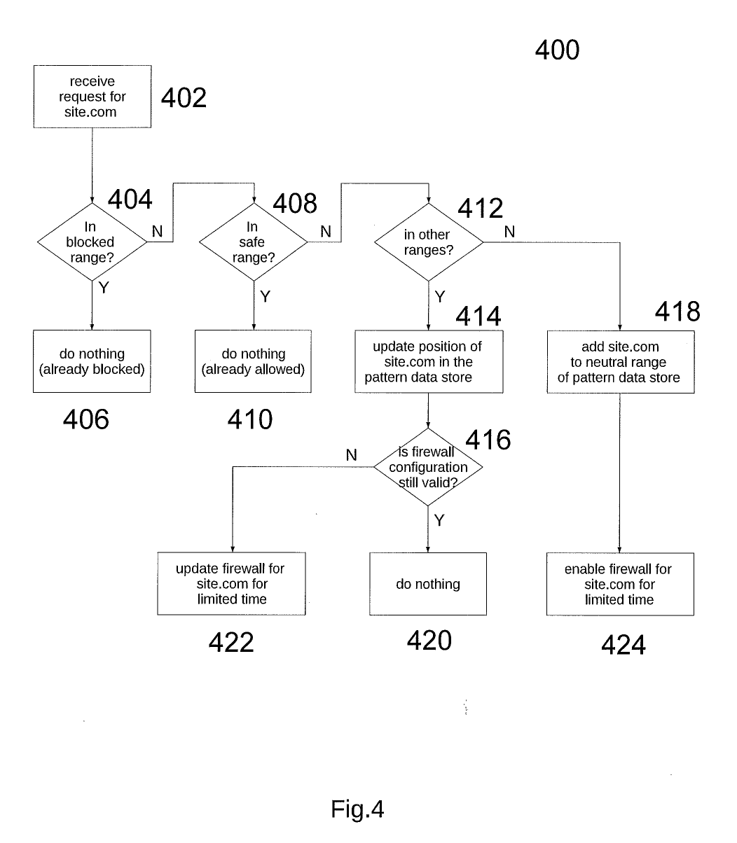

FIG. 4 shows an example of the control logic of a method 400 for configuring hardware to determine admissibility using the pattern data store. At 402, network security supervisor 107 receives a request from a computing device 101 to contact site.com. At 404, network security supervisor 107 determines whether site.com is in the blocked range of the accessibility spectrum. If it is, at 406, then the firewall or other network security device may be configured to refuse access to site.com 112.

At 408, the network security supervisor 107 may check in its pattern data storage device 105 to determine whether site.com 112 is in the safe range of the spectrum. If it is, then at 410 the firewall or other network security device may be configured to allow access to site.com 112.

At 412, the network security supervisor 107 may check in its pattern data storage device 105 to determine whether site.com 112 is in another range of the spectrum, such as the neutral range. For example, the network security supervisor 107 may check in its pattern data storage device 105 whether this is the first time a device has requested site.com (e.g. FIG. 3 at 310 with a determination that IP address not already set). In the case of the first access, at 418, the network security supervisor 107 may record the domain in the neutral spectrum in the pattern data storage device 105 and send a message to the firewall 106 or other network security device to allow access to site.com 112 by device 101 for a predetermined validity period at 424.

At 414, the network security supervisor 107 may modify the position of the domain in the accessibility spectrum based on the frequency of access, time since the first access, registration(s) of the computing device 101, network location of the client, type of device, time of day, and volume of network requests to move the domain towards the familiar range of the spectrum or towards the suspect range of the spectrum. For example, if a new site is requested by a single client, it may be placed in the neutral part of the spectrum, but as time passes and with subsequent requests by more than one client it may be migrated towards the familiar part of the spectrum. If a large number of client devices request this site then it may be migrated further towards the safe part of the spectrum. Modifications and updates may also occur for sites that are in the safe range or blocked range.

In one embodiment, a computer user interface may be provided for a security administrator to view a representation of the spectrum and to manually add or remove a site or to modify the positions of one or more sites within the spectrum based on external criteria. The computer user interface may render graphical representations of captured network events correlated to values on the spectrum.

The network security supervisor 107 may re-configure one or more security devices after expiration of a predetermined time period. At 416, the network security supervisor 107 may determine whether the firewall configuration is still valid. In a case where the device 101 has accessed site.com 112 before, the network security supervisor 107 may not have to do anything until the validity period has expired (at 420). At 422, the network security supervisor 107 may update the firewall 106 or other network security device with the IP address and the validity time if any of the values have changed.

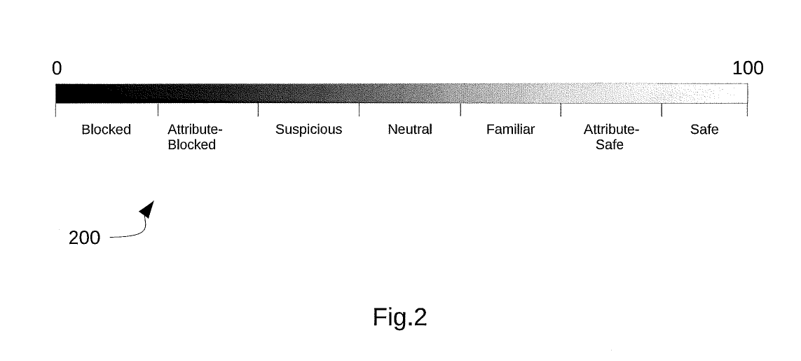

FIG. 2 shows a sample representative of the relative ranges of the admissibility spectrum 200.

In accordance with some embodiments, the network security supervisor 107 may notify one or more network monitors, such as the Address Manager 113, when a request occurs to a site in the blocked spectrum range.

In accordance with other embodiments, the network security supervisor 107 may notify one or more network monitors, such as the Address Manager 113, when a request occurs to a site in the suspect spectrum range.

In the case that device 101 attempts to contact an IP address for an unknown site 110 that has not been configured according to the embodiments described herein, no access may be permitted by the firewall 106.

In the case that device 101 attempts to contact an IP address for a site that has been listed in the blocked spectrum, such as ‘badsite.com’ 111, no access may be permitted by the firewall 106.

In accordance with some embodiments described herein, a computing device 101 may obtain its IP address from a DHCP service 103. DHCP is a network protocol used to configure devices that are connected to a network so they can communicate on that network using the Internet Protocol. The DHCP service 103 may determine one or more pieces of identifying information of computing device 101 to the network security supervisor 107. Example identifying information may include one or more of, but not limited to, a hardware MAC address, a digital fingerprint and an identifying token, and so on. From the device identifier the network security supervisor 107 may be able to determine the type attribute of the device. The user of the computing device 101 may initiate contact with an Internet site ‘site.com’ 112 whereby the device 101 may first contact DNS service 102 in order to obtain the IP address of the site. The DNS service may return the requested IP address for ‘site.com’ 112 and at the same time notify the network security supervisor 107 that the device 101 wishes to contact site.com 112.

The network security supervisor 107 may then check its pattern data storage device or data store 105 to determine whether site.com 112 is in the attribute-specific blocked spectrum and if it is then the network security supervisor 107 may set up the firewall 106 to refuse access to site.com 112. The network security supervisor 107 may then check its pattern data storage device or data store 105 to determine whether site.com 112 is in the attribute-specific safe spectrum and if it is, then the network security supervisor 107 may set up the firewall 106 to allow access to site.com 112. The network security supervisor 107 may then check its pattern data storage device or data store 105 to determine whether site.com 112 is in neither and the network security supervisor 107 may then check whether this is the first time a device 101 has requested the site.

In the case of the first access, the network security supervisor 107 may set the firewall 106 to allow access to site.com 112 by type attribute of device 101 for a predetermined period and may record this in its pattern data storage device 105. In the case where the device 101 has accessed site.com 112 before the network security supervisor 107 may not have to do anything until the predetermined period has expired.

In another aspect of embodiments described herein, the user of computing device 101 may access the registration service 104 directly or indirectly by accessing a service that in turn accesses the registration service 104, which may submit the user attribute, user group attribute and the hardware identifier of the computing device 101 to the network security supervisor.

The network security supervisor 107 may check whether site.com 112 is in the user-attribute blocked range and if it is then the network security supervisor 107 may set up the firewall 106 to refuse access to site.com 112. The network security supervisor 107 may check whether site.com 112 is in the user-attribute safe range and if it is, then the network security supervisor 107 may set up the firewall 106 to allow access to site.com 112. The network security supervisor 107 may check whether site.com 112 is in neither and the network security supervisor 107 may then check its pattern data store 105 to determine whether this is the first time a device has requested the site.

In the case of the first access, the network security supervisor 107 may set the firewall 106 to allow access to site.com 112 by the user on device 101 for a predetermined period and may record this in its pattern data store 105. In the case where the device 101 has accessed site.com 112 before the network security supervisor 107 may not have to do anything until the predetermined period has expired.

As shown in FIG. 2, a data structure may link network data events to a range on the admissibility spectrum 200.

In accordance with some embodiments, examples of handling of admissibility spectrum may be include:

Safe Range: These domains may be predetermined and specifically tagged as safe and may be never blocked. Trusted sites, such as search engines, government sites, patent office sites, and popular sites are included in this range. Domains that are accessed frequently and over a long period may automatically be added to the safe range, and conversely, safe domains that are not accessed for a long time may gradually migrate out of the safe range. In addition to domains and addresses that are determined by monitoring, lists of commonly accessed may be obtained from Internet information providers. For example Alexa/Amazon (alexa.com) may provide lists of the most accessed sites, sorted by category and geography.

Attribute-safe range: These domains may be predetermined and specifically tagged as safe conditionally depending on some specified attribute, such as (but not limited to) device type, time window, originating user, user group or requests originating from a specific network block or location. This may allow blocked domains to be overridden for specific conditions. For example, ‘ebay.com’ may be blocked by both the DNS service 102 and the firewall 106 for all employees except the facilities managers. In another example, corporate accounting servers may be blocked to all, but allowed for client devices from a particular network location.

Familiar range: Domains in the familiar range may be dynamically and automatically determined based on usage patterns, such as a minimum number of requests for the site per day across multiple systems. These domains are observed to be used by significant numbers of devices and are therefore considered safe enough to unblock the firewall 106 for all users.

Neutral range: A device accessing a domain in the neutral range may be required to perform a DNS query and receive a response before the firewall 106 may be enabled by the network security supervisor 107 to permit traffic to this domain. The initial DNS response to the device 101 may be delayed by the DNS service 102 until the network security supervisor 107 has configured the firewall 106 for this domain. The time-to-live of the DNS response may be modified to be equal to or less than the time-to-live of the firewall configuration for the domain. Subsequent accesses to the site associated with the domain by any device may not require further DNS queries until the firewall time-to-live expires.

Suspect range: A device attempting to access a domain in the suspect range may be required to perform a DNS query and receive a response before the firewall 106 may be enabled to permit traffic to this domain. The DNS response to the device 101 may be delayed by the DNS service 102 until the network security supervisor 107 has configured the firewall 106 for this domain. The time-to-live of the DNS response and the time-to-live of the firewall configuration for the domain may be modified to be small to provide a relatively short window of access. Subsequent accesses to the site associated with the domain by any other device may be blocked and further DNS queries may be required to continue to access the site. In a further aspect, the firewall may be configured to restrict the traffic from the device to a limited number of Internet Protocol ports, such as (but not limited to) the ports 80 and 443, as well providing additional restrictions as described herein. In yet another aspect of embodiments described herein, the network security supervisor 107 may quarantine the domain for a predetermined period of time and not permit firewall access to the domain until the quarantine expires. This may allow DNS query attempts to be captured for security alerting and logging and may also allow the domain to be verified by an external process. Flagging of a suspect domain may occur in a number of ways, for example, the domain may be requested by a client that has also previously tried to request a blocked site. In another example the domain, say ‘abcd.badsite.com’, may be markedly similar to a known blocked domain, say ‘abc.badsite.com’.

Attribute-blocked range: These domains are predetermined and specifically tagged as blocked conditionally on some specific attribute, such as (but not limited to) device type, time window, originating user or requests originating from a specific network block. This will allow selected domains to be overridden for specific conditions. For example, social networking sites may be blocked for clinical computing devices 101.

Blocked range: These domains are considered unsafe and may not be accessed by any devices. Devices that perform DNS queries to these domains may receive no responses or be redirected to safe sites. The DNS query attempts may also be captured for security alerting and logging. Blocked domains may be obtained from internal or external providers of domain lists. For example, lists of known virus-infected sites, adult sites, phishing sites and others may be acquired and included in the blocked range. In another example, blocked domains may be shared between peer systems, so a domain blocked on one will propagate to be blocked in the others.

In one embodiment, a computer user interface may provide different view representations of the spectrum, for various end users such as for a security administrator. Tracking when and how often a site is requested may provide limited insight into the behavior of the network, a computer interface may provide a characterization of the site using the spectrum of admissibility to greatly enhance the value of the site request information. Likewise, the tracking of client device requests may be greatly enhanced by relating them to positions on the spectrum of admissibility, thereby enabling an administrator to focus on the dubious or notable cases and ignore the remainder. In particular this may draw attention to the services accessed by the devices on the network, security of the network, apparent threats, misuse, and performance bottlenecks. For example, if a client device was previously provisioned by a network service such as a trusted virtual machine provider service, then the client device may be placed in the ‘safe’ region of the spectrum of admissibility. A client provisioned by a public wireless service may be placed in the ‘neutral’ region of the spectrum and a previously unknown client device may be placed in the ‘suspicious’ or ‘blocked’ region of the spectrum. Domain queries may then be treated according to the positions of the corresponding client devices in the spectrum of admissibility by dynamically configuring the network firewall.

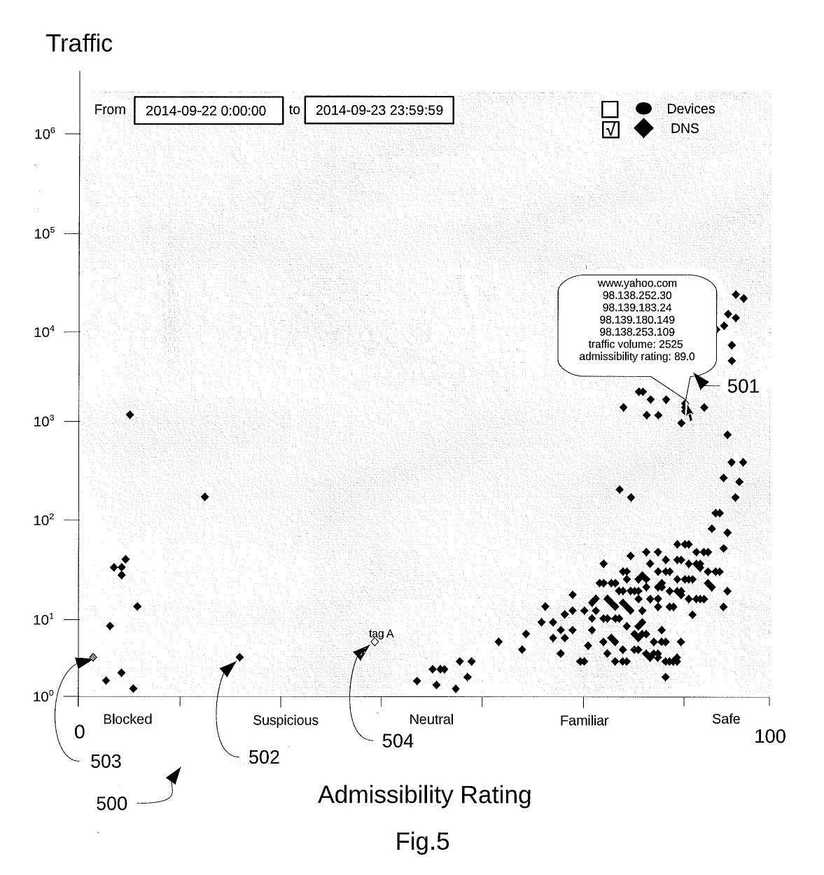

As illustrated in FIG. 5, a network may be represented as visualization 500 using the admissibility spectrum displayed along the x axis of the graph visualization 500. Providing an indication of request relative to a position on the spectrum may provide insight into the threats and characteristics of the network. For example, the administrator may wish to activate (e.g. click on) indication requests and investigate requests in the visual display that appear out-of-the-ordinary by displaying additional data attributes 501. The visualization 500 may display different segments of the data. For example, the visualization 500 may only display DNS requests. As another example, the visualization 500 may only display device requests.

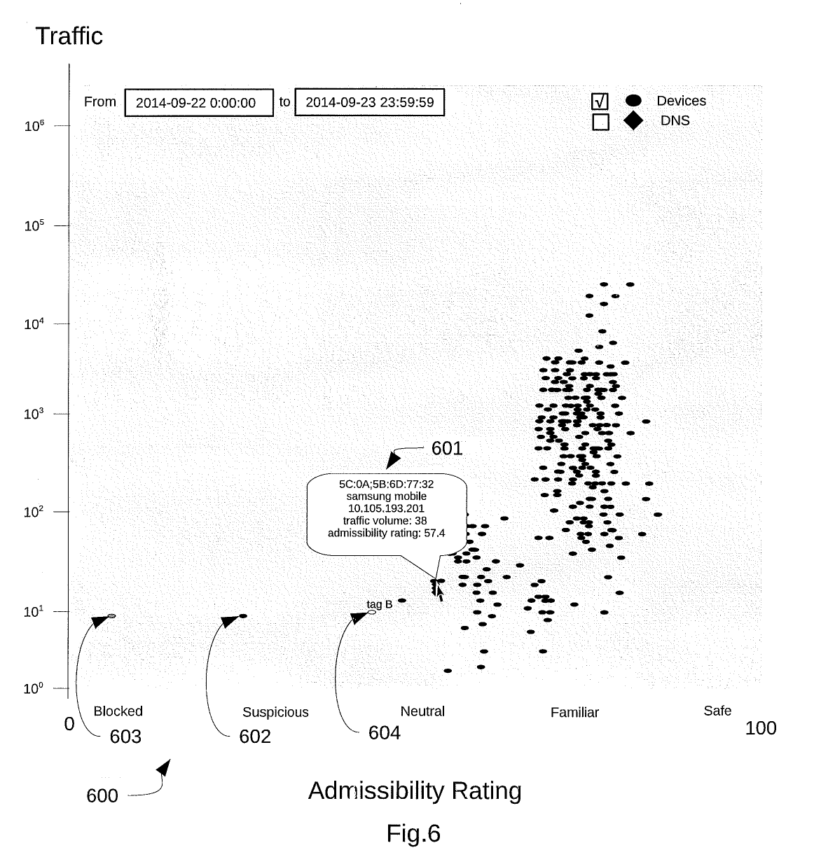

As illustrated in FIG. 6, a network may be represented as visualization 600 using the admissibility spectrum (e.g. displayed on the x axis of graph visualization 600) and may provide insight into the client devices on the network, including displaying data attributes 601. The user interface may also assist the administrator to improve the security and performance of the network by responding to requests to add or remove a site or client on the spectrum of admissibility or to modify the positions of one or more sites or client devices within the spectrum based on external criteria and save this in the spectrum of admissibility, thereby altering the firewall behavior for that site or client. For example, the administrator may select one or more sites shown on a graphical visual display and, using a graphical computer user interface, perform an operation such as moving or fixing the positions of the one or more sites on the admissibility axis, associating the sites with a group, adding a tag identifier to the sites and so on. Likewise, similar operations may be performed on the visual representations of client devices. Accordingly, the interface may provide a mechanism to trigger alteration or modification of a physical network security device. Further, the interface may provide a mechanism to modify the spectrum of admissibility which in turn modifies access or denial by a physical network security device to a site, client device, and so on positioned on the spectrum of admissibility.

Accordingly, input commands received at the interface of the visualization 500/600 may result in physical updates to the network firewall.

For example, an input command may reassign a site shown in the visualization 500 or a client device in the visualization 600 by dragging its icon from an existing position 502/602 to a new position 503/603. In another example, a site 504 or client 604 may be tagged for future observation, reporting and display.

In a further aspect of embodiments described herein may involve sharing pattern data store lists across different systems and devices. The pattern data storage device 105 may be distributed and synchronized between a plurality of systems 100 so that a domain entry entered by one system 100 may be made available to the other systems 100 and merged with the data existing in the other data stores. Network security devices for determining the position of a domain, address, user, device or application on the spectrum of admissibility may therefore use the collective data store as input. This may allow efficient convergence of values for sites on the spectrum by aggregating many data points as well as efficient propagation of information about both good and bad sites. For example, a network security device that detects suspicious malware access behavior in one network system may be able to propagate this information via the spectrum of admissibility to another network system even before the malware reaches that network system.

In accordance with some embodiments, the pattern data storage device 105 may be a centralized, shared resource that is accessed by a plurality of network security supervisors 107 over the computer network.

In a further aspect of embodiments described herein may involve IP and block reputation. In addition to containing domain entries arranged according to their position on the admissibility spectrum 200, the pattern data storage device 105 may also contain IP addresses and IP address blocks. As with domains, IP addresses may be obtained from the safe or blocked lists. In some embodiments, these IP addresses may be used to configure the firewall settings and may be matched against the DNS responses to ensure that DNS responses do not override these IP address firewall settings. The pattern data storage device 105 may store additional data include attributes and information about devices, and so on.

In a further aspect of embodiments described herein may involve QoS modification. QoS settings for firewall/gateways or other network security devices may be configured to prioritize network traffic. In some aspects of embodiments described herein, the quality-of-service(QoS) setting for the firewall Internet connection for a domain may be set according to the position of the domain on the accessibility spectrum. Hence domains on the safe side of the spectrum may receive higher QoS (and therefore lower latency) than domains on the blocked side of the spectrum. Domains in the suspect range may not be able to inflict effective denial-of-service (DoS) attacks due to the imposed network delays.

In some embodiments, the firewall/gateway 106 may allow for a plurality of network queues, each queue corresponding to a class of service, wherein the IP address of the said domain may be added to the appropriate class configuration in order to cause the messages to the said domain to be placed on the corresponding queue.

In a further aspect of embodiments described herein may involve DNS profiles (e.g. sequences of DNS requests). Patterns of DNS domain queries performed by the same device within a timeframe may be associated with a domain profile by the network security supervisor 107. For example, a request for daisy.ubuntu.com may suggest the client is running the Linux operating system and may be therefore a member of the Linux profile. As another example, domain queries by client devices at positions in the spectrum of admissibility within a user-specific safe range of the spectrum, may result in the network security supervisor 107 improving positions of the domain queries in the spectrum of admissibility based on the client devices. Accordingly, requests from client devices that are considered ‘safe’ clients may in turn be considered ‘safe’ requests and may be modified to an improved position on the spectrum of admissibility. In contrast, domain queries by client devices at positions in the spectrum of admissibility within a user-specific unsafe range of the spectrum, may result in the network security supervisor 107 reducing positions of the domain queries in the spectrum of admissibility based on the client devices.

The position of a domain on the spectrum of admissibility is a dynamic value that may continuously be modified depending on factors directly or indirectly related to the domain queried. The position of a domain on the spectrum of admissibility may not be a fixed value, but may be a dynamic computed value based on a set of attributes and captured information that continuously updates. Captured information may include, for example, the starting point or administrator-set point of the domain on the spectrum, the frequency and time distribution of the domain queries, the groups the domain is associated with and their positions on the spectrum of admissibility, the number and ranking of the client devices making the request and their positions on the spectrum of admissibility, the software applications, if any, associated with the domain and their positions on the spectrum of admissibility and so on. The position of one or more client devices on the spectrum of admissibility may similarly be a dynamic computed value based on a set of attributes and continuously captured information including, for example, the starting point or administrator-set point of the client MAC address on the spectrum, the position on the spectrum of the server issuing the client IP address, the frequency and time distribution of queries from the client, the positions of the spectrum of domains queried by the client, the groups the client is associated with and their positions on the spectrum of admissibility, the applications, if any, associated with the client and their positions on the spectrum of admissibility, and so on.

In addition to this, associating a device type with a domain profile may allow the network security supervisor 107 to determine that the device is running a particular software application. The network security supervisor 107 may compare the discovered application with a list of permitted applications in the safe list 108 or blocked applications in the blocked list 109 and use this to place the domains on the admissibility spectrum. This may allow applications to be allowed or blocked accordingly by the firewall 106.

In a further aspect of embodiments described herein may involve device registration. In another aspect of embodiments described herein, a device 101 may contact a registration service 104. The registration service 104 may comprise at least one processor and memory, examples are described herein. The Registration service may determine the admissibility of the device 101 to access resources, such as may be accessed by IP address or domain name, by requesting one or more admissibility criteria or attributes, including for example, a) credentials from the user, for example (but not limited to) identifiers and passwords, b) agreements or acknowledgements, for example terms-of-service acceptance, c) authorization or payment of some kind, and so on. Upon the device 101 passing the admissibility criteria, the registration service 104 may submit information to the network security supervisor 107 for domains and IP addresses associated with sites and applications permitted to be used by the device 101 to be added to the admissibility spectrum.

In a further aspect of embodiments described herein may involve device provisioning. In another aspect of embodiments described herein, a device 101 may be provisioned with an IP address by a service, for example a DHCP service 103, in accordance with a predetermined configuration. This information may be submitted to the network security supervisor 107 for use in the firewall 106 or other network security device configuration. For example, the network security supervisor 107 may not enable accessibility through the firewall 106 to devices 101 that have not been provisioned by the DHCP service 103. In another aspect of embodiments described herein, the network security supervisor 107 may not enable accessibility through the firewall to devices that have not been provisioned in a predetermined location.

In a further aspect of embodiments described herein may involve transient networks with DNS entries updates. The IP address obtained from a DNS domain name response may be checked against the IP address obtained previously from a query to the same domain. Domains that are neither blocked nor safe and with IP addresses that do not change may be advanced in the admissibility spectrum (to become safer) whereas domains with addresses that do change from time to time may be lowered in the spectrum (to become less safe). If the domain has not been requested for a predetermined length of time an agent may be tasked to perform a DNS query to determine whether the domain still exists and the result of this query may be used to verify the domain position as described herein.

In a further aspect of embodiments described herein may involve rule instantiation and data flow instantiation. Firewall configuration may be expressed in rules. The firewall manager 107 may update the firewall configuration using rules to configure the firewall instead of IP address configurations. For example, the firewall may be configured to permit access to a specific IP address by a specific IP address on a specific port within a certain time-of-day window. In another example, a firewall may include one or more Software Defined Networking (SDN) switches including a technology such as OpenFlow that allows data flow rules within the switches to be created and torn down in response to external instructions.

The following illustrative example scenarios are examples of the different types of access that may be handled by embodiments described herein.

Computing device 101 attempts access to known site (e.g. mycompany.com), which may be considered a ‘safe’ domain because it appears on a list of well-known, common domains, and therefore may be entered in the safe part of the spectrum. No restrictions (i.e. no DNS requests required) or logging may apply to this domain. Hence the firewall may be set up to allow the IP addresses associated with this domain on a long term basis for all devices 101.

Computing device 101 attempts access to very common site (e.g. yahoo.com) which may be considered a ‘familiar’ domain because it receives a large number of network requests every day, and therefore may automatically migrate from the familiar part to the safe part of the spectrum as more users accessed it over time. After a while no restrictions may apply (i.e. prior DNS requests needed) to this domain, but logging may still be carried out. Hence the firewall may be set up periodically to allow the IP addresses for a limited time for all devices 101.

Computing device 101 attempts access to new site (e.g. newtravelsite.com). Since the new site is unknown, a DNS query/reply may be needed before the access can be allowed. Upon a successful query, the firewall may be set up to allow access to the IP address of this site for a short time only for this device 101 only. This access may also be logged. In particular, this log may be shared with other firewall supervisors so that they may be aware of this new site. There may also be a short delay in sending the DNS response to the device 101 to give the service time to set up the firewall and also to limit the number of accesses should there be an attack on the system using this domain.

Computing device 101 attempts access to new site often (e.g. newtravelsite.com). Subsequent attempts to access this site may result in the same behaviour as described herein, but the delay may be progressively reduced to zero as the site becomes more trusted. This may move the site to different more trusted positions along the spectrum. In addition, log messages from other firewall supervisors may be used to increase (or decrease) trust in this site as well, depending on the trust values of the other supervisors. This site may become suspicious if it is associated with other suspicious activity, for example the device 101 in question visits other suspicious sites, and in that case the delay may be increased.

Computing device 101 attempts access to discouraged site (e.g. buystuff.ca). There are a number of actions that may be associated with a site that is discouraged. For example, the site may be treated as a new site on every access. In addition, the first time a user tries to access this site the DNS response may be modified to redirect the user to a policy web page that explains why the site is ‘discouraged’. There may also be service restrictions configured on the firewall; for example only certain IP ports may be allowed, and the QoS may be set low, so that flooding of the network by this device 101 may be impeded.

Computing device 101 attempts access to restricted site (gamblingsite.com). Access to a ‘restricted’ site may be treated similarly to the ‘discouraged’ site, with the addition of a redirect to a policy web page or an authorization page on every attempt. Access may also be unconditionally prohibited for some device 101 and not for others.

Computing device 101 attempts access to prohibited site (verybadsite.cn). Access to a ‘prohibited’ site may be considered unsafe and be blocked in every case. However, a device 101 that makes a DNS query for such a site may be redirected to a policy web page or may simply receive no response.

Computing device 101 may attempt access to an IP address without first performing a DNS query. Default operation of the firewall may be to block access to destination IP addresses except for IP addresses previously configured as allowed. Each allowance may be associated with a validity timeframe, and some may also be associated with a particular source IP address. Firewall rules also typically allow finer control, with particular ports (i.e. services) allowed or blocked and, where deep packet inspection is supported, detailed protocol support may be possible too.

Computing device 101 accesses a pattern of sites (site1.com, site2.com, site3.com . . . ) An interesting aspect of embodiments described herein is the ability to correlate access attempts in order to classify domains and addresses for sites in a manner that is not addressed by the prior art. For example, if a particular site access is usually preceded by an access to a known trusted site (say google.com) then it may boost the trust of the site in question. Likewise, if a client accesses a suspicious site, subsequent sites accessed may be downgraded. A pattern of sites accessed may be representative of a software application, and therefore all the sites in the pattern may be given the same level of trust, which may be different for the sites when they are accessed independently. This may apply to a particular host within a site, say host.site1.com and its associated IP address which may be trusted as safe in conjunction with other accesses, whereas site1.com on its own may be considered unsafe. For example, a web site that is accessed at ‘travelsite.com’ may in turn reference content (advertisements, images, etc.) at a number of other sites and IP addresses. These sites and addresses, when requested by the same client, may be all located together on the accessibility spectrum, whereas they may be treated as suspect if accessed separately from the initial ‘travelsite.com’ access.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, virtual machine computing component, cloud computing device, set-top box, embedded device, computer expansion module, personal computer, laptop, personal data assistant, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication. In still other embodiments, there may be a combination of communication interfaces implemented as hardware, software, and combination thereof.

Each program may be implemented in a high level procedural or object oriented programming or scripting language, or a combination thereof, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. One should appreciate that the systems and methods described herein may dynamically configure network security devices to deny or permit network access between those devices and network resources, as described herein.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The scope of the claims should not be limited by the described embodiments and examples but should be given the broadest interpretation consistent with the description as a whole.

What is claimed is:

1. A method for updating configuration of one or more network security apparatuses, the method comprising;
capturing, at a processor, network activity events by a plurality of computing network devices, wherein each network activity event references a network data resource;
providing, in a data store, a spectrum of admissibility of network access;
for each network data resource referenced by a network activity event:
determining, using the processor, a position in the spectrum of admissibility of the respective network data resource;
storing, in the data store, a network data resource record, wherein the network data resource record comprises a network data resource identifier identifying the respective network data resource and the position in the spectrum of admissibility of the respective network data resource; and
configuring, using the processor and the network data resource record, one or more network security apparatuses to allow or deny access to the respective network data resource according to the position in the spectrum of admissibility of the respective network data resource.

2. The method of claim 1, wherein a network data resource comprises an IP address associated with a DNS domain name.

3. The method of claim 2, further comprising intercepting and delaying DNS response network activity until after configuring of the network security apparatus.

4. The method of claim 3, further comprising intercepting and delaying DNS response network activity until after a pattern of domain queries is received or a timeout occurs.

5. The method of claim 2, wherein the network activity events comprise one or more domain queries by one or more client devices, wherein the one or more client devices are at positions in the spectrum of admissibility within a user-specific safe range of the spectrum, wherein the method further comprises improving positions of the one or more domain queries in the spectrum of admissibility based on the one or more client devices.

6. The method of claim 2, wherein the network activity events comprise one or more domain queries by one or more client devices, wherein the one or more client devices are at positions in the spectrum of admissibility within a user-specific unsafe range of the spectrum, wherein the method further comprises reducing positions of the one or more domain queries in the spectrum of admissibility based on the one or more client devices.

7. The method of claim 2, wherein the network activity events comprise a pattern of domain queries, wherein the method further comprises mapping a pattern of domain queries to a software application on a spectrum of admissibility of applications.

8. The method of claim 1, wherein a network data resource comprises a device identifier and device type associated with a network IP address.

9. The method of claim 8, further comprising:
capturing a user identifier of a user associated with a network computing device of the plurality of network computing devices, wherein the network computing device is associated with the network IP address;
determining a position of the user on the spectrum of admissibility;
storing, in the data store, a user record, wherein the user record comprises the user identifier of the user, the device identifier, the device type and the position of the user in the spectrum of admissibility; and
configuring, using the processor, the one or more network security apparatuses to allow or deny access to a network data resource associated with the user using the user record.

10. The method of claim 8, further comprising:
capturing a user group identifier of a user associated with a network computing device of the plurality of network computing devices, wherein the network computing device is associated with the network IP address;
determining a position of the user group on the spectrum of admissibility;
storing, in the data store, a user group record, wherein the user record comprises the user group identifier of the user, the device identifier, device type and the position of the user in the spectrum of admissibility; and
configuring, using the processor, the one or more network security apparatuses to allow or deny access to a network data resource associated with the user using the user group record.

11. The method of claim 1, further comprising:
sharing and coordinating the spectrum of admissibility stored in the data store with the plurality of network computing devices to capture additional network activity events;
updating network data resource records based on the additional network activity events; and
updating configuration of the one or more network security apparatuses based on the updated network data resource records.

12. The method of claim 1, further comprising allowing access, by the one or more network security apparatuses, to a destination network resource by setting a QoS for the destination network resource.

13. The method of claim 1, further comprising updating the configuration of the one or more network security apparatuses by setting one or more rules for later execution by the one or more network security apparatuses.

14. The method of claim 1, further comprising providing a user interface displaying network characteristics in a graphical form as a representation of a status and activity of the network, wherein a first axis of the graphical form comprises the spectrum of admissibility.

15. The method of claim 14, wherein a second axis of the graphical form comprises the frequency of access requests for one or more network resources.

16. The method of claim 14, whereby a second axis of the graph comprises the frequency of site requests from a client device.

17. The method of claim 14, further comprising receiving command requests at the user interface to update the position in the spectrum of admissibility of a network resource, and re-configuring the one or more network security apparatuses in response to the command request.

18. A system for updating configuration of one or more network security apparatuses:
a data store storing a spectrum of admissibility of network access and a plurality of network data resource records;
a network security controller comprising a processor configured to:
capture network activity events by a plurality of computing network devices, wherein each network activity event references a network data resource;
for each network data resource referenced by a network activity event:
determine a position in the spectrum of admissibility of the respective network data resource;
updating a network data resource record of the plurality of network data resource records, wherein the network data resource record comprises a network data resource identifier identifying the respective network data resource and the position in the spectrum of admissibility of the respective network data resource; and
configure, using the updated network data resource record, one or more network security apparatuses to allow or deny access to the respective network data resource according to the position in the spectrum of admissibility of the respective network data resource.

19. The system of claim 18, wherein the network data resource comprises an IP address associated with a DNS domain name.

20. The system of claim 18, wherein the network data resource comprises a device identifier and device type associated with a network IP address.

21. The system of claim 20, wherein the a network security controller is further configured to capture a user identifier for a user associated with the network computing device associated with the network IP address and determine a position of the user on the spectrum of admissibility.

22. The system of claim 20, wherein the a network security controller is further configured to capture a user group identifier for a user associated with the network computing device associated with the network IP address and determine a position of the user group on the spectrum of admissibility.

23. The system of claim 18, further comprising a display device configured with a user interface displaying network characteristics in a graphical form as a representation of a status and activity of the network, wherein a first axis of the graphical form comprises the spectrum of admissibility.

24. A computing device for monitoring and controlling network activity and updating configuration of a network security apparatus, the device comprising:
one or more components to access, in a data store, a spectrum of admissibility of network access and a plurality of network data resource records;
one or more components to capture network activity events by a plurality of computing network devices, wherein each network activity event references a network data resource;
for each network data resource referenced by a network activity event, one or more components to:
determine a position in the spectrum of admissibility of the respective network data resource;
update a network data resource record of the plurality of network data resource records, wherein the network data resource record comprises a network data resource identifier identifying the respective network data resource and the position in the spectrum of admissibility of the respective network data resource; and
configure, using the updated network data resource record, one or more network security apparatuses to allow or deny access to the respective network data resource according to the position in the spectrum of admissibility of the respective network data resource.

25. The computing device of claim 24, wherein the network data resource comprises an IP address associated with a DNS domain name.

26. The computing device of claim 24, wherein the network data resource comprises a device identifier and device type associated with a network IP address.

27. The computing device of claim 26, wherein the device comprises one or more components for capturing a user identifier for a user associated with the computing device associated with the network IP address and determining a position of the user on the spectrum of admissibility.

28. The computing device of claim 26, wherein the device comprises one or more components for capturing a user group identifier for a user associated with the computing device associated with the network IP address and determining a position of the user on the spectrum of admissibility.

29. The computing device of claim 24, further comprising a display device configured with a user interface displaying network characteristics in a graphical form as a representation of a status and activity of the network, wherein a first axis of the graphical form comprises the spectrum of admissibility.
